(19) United States
(12) Patent Application Publication
(10) Pub. No.: US 2015/0263980 A1
(43) Pub. Date: Sep. 17, 2015

(54) METHOD AND APPARATUS FOR RAPID INSTANCE DEPLOYMENT ON A CLOUD USING A MULTI-CLOUD CONTROLLER

(71) Applicants: Rohini Kumar Kasturi, Sunnyvale, CA (US); Bojjiraju Satya Tirumala Nanduri, Fremont, CA (US); Vijay Sundar Rajaram, Fremont, CA (US); Venkata Siva Satya Phani Kumar Gattupalli, (US); Tushar Rainkant Jagtap, (US)

(72) Inventors: Rohini Kumar Kasturi, Sunnyvale, CA (US); Bojjiraju Satya Tirumala Nanduri, Fremont, CA (US); Vijay Sundar Rajaram, Fremont, CA (US); Venkata Siva Satya Phani Kumar Gattupalli, (US); Tushar Rainkant Jagtap, (US)

(21) Appl. No.: 14/214,612

(22) Filed: Mar. 14, 2014

Related U.S. Application Data
(63) Continuation-in-part of application No. 14/214,572, filed on Mar. 14, 2014.
Application No. 14/214,572 is a continuation-in-part of application No. 14/214,472, filed on Mar. 14, 2014.
Application No. 14/214,472 is a continuation-in-part of application No. 14/214,326, filed on Mar. 14, 2014.

(51) Int. Cl. H04L 12/911; H04L 12/26; H04L 12/851

(52) U.S. Cl. CPC H04L 47/70; H04L 47/24; H04L 43/04

(57) ABSTRACT

A multi-cloud fabric includes an application management unit responsive to one or more applications from an application layer. The multi-cloud fabric further includes a controller that is in communication with resources of a cloud. The controller is responsive to the received application and includes a processor operable to analyze the received application relative to the resources to cause delivery of the one or more applications to the resources dynamically and automatically.

### CROSS REFERENCE TO RELATED APPLICATIONS

This application is a continuation-in-part of U.S. patent application Ser. No. 14/214,572, filed on Mar. 14, 2014, by Kasturi et al., and entitled “METHOD AND APPARATUS FOR ENSURING APPLICATION AND NETWORK SERVICE PERFORMANCE IN AN AUTOMATED MANNER”, which is a continuation-in-part of U.S. patent application Ser. No. 14/214,472, filed on Mar. 14, 2014, by Kasturi et al., and entitled “PROCESSES FOR A HIGHLY SCALABLE, DISTRIBUTED, MULTI-CLOUD SERVICE DEPLOYMENT, ORCHESTRATION AND DELIVERY FABRIC”, which is a continuation-in-part of U.S. patent application Ser. No. 14/214,326, filed on Mar. 14, 2014, by Kasturi et al., and entitled “METHOD AND APPARATUS FOR A HIGHLY SCALABLE, MULTI-CLOUD SERVICE DEPLOYMENT, ORCHESTRATION AND DELIVERY”, which are incorporated herein by reference as though set forth in full.

### FIELD OF THE INVENTION

Various embodiments of the invention relate generally to a multi-cloud fabric and particularly to a Multi-cloud fabric with distributed application delivery.

### BACKGROUND

Data centers refer to facilities used to house computer systems and associated components, such as telecommunications (networking equipment) and storage systems. They generally include redundancy, such as redundant data communications connections and power supplies. These computer systems and associated components generally make up the Internet. A metaphor for the Internet is cloud.

A large number of computers connected through a real-time communication network such as the Internet generally form a cloud. Cloud computing refers to distributed computing over a network, and the ability to run a program or application on many connected computers of one or more clouds at the same time.

The cloud has become one of the, or perhaps even the, most desirable platform for storage and networking. A data center with one or more clouds may have real server hardware, and in fact served up by virtual hardware, simulated by software running on one or more real machines. Such virtual servers do not physically exist and can therefore be moved around and scaled up or down on the fly without affecting the end user, somewhat like a cloud becoming larger or smaller without being a physical object. Cloud bursting refers to a cloud becoming larger or smaller.

The cloud also focuses on maximizing the effectiveness of shared resources, resources referring to machines or hardware such as storage systems and/or networking equipment. Sometimes, these resources are referred to as instances. Cloud resources are usually not only shared by multiple users but are also dynamically reallocated per demand. This can work for allocating resources to users. For example, a cloud computer facility, or a data center, that serves Australian users during Australian business hours with a specific application (e.g., email) may reallocate the same resources to serve North American users during North America's business hours with a different application (e.g., a web server). With cloud computing, multiple users can access a single server to retrieve and update their data without purchasing licenses for different applications.

Cloud computing allows companies to avoid upfront infrastructure costs, and focus on projects that differentiate their businesses instead of infrastructure. It further allows enterprises to get their applications up and running faster, with improved manageability and less maintenance, and enables information technology (IT) to more rapidly adjust resources to meet fluctuating and unpredictable business demands.

Fabric computing or unified computing involves the creation of a computing fabric consisting of interconnected nodes that look like a ‘weave’ or a ‘fabric’ when viewed collectively from a distance. Usually this refers to a consolidated high-performance computing system consisting of loosely coupled storage, networking and parallel processing functions linked by high bandwidth interconnects.

The fundamental components of fabrics are “nodes” (processor(s), memory, and/or peripherals) and “links” (functional connection between nodes). Manufacturers of fabrics include IBM and Brocade. The latter are examples of fabrics made of hardware. Fabrics are also made of software or a combination of hardware and software.

A data center employed with a cloud currently suffers from latency, crashes due to underestimated usage, inefficiently uses of storage and networking systems of the cloud, and perhaps most importantly of all, manually deploys applications. Application deployment services are performed, in large part, manually with elaborate infrastructure, numerous teams of professionals, and potential failures due to unexpected bottlenecks. Some of the foregoing translates to high costs. Lack of automation results in delays in launching business applications. It is estimated that application delivery services currently consumes approximately thirty percent of the time required for deployment operations. Additionally, scalability of applications across multiple clouds is nearly nonexistent.

There is therefore a need for a method and apparatus to decrease bottleneck, latency, infrastructure, and costs while increasing efficiency and scalability of a data center.

### SUMMARY

Briefly, an embodiment of the invention includes a multi-cloud fabric that includes an application management unit responsive to one or more applications from an application layer. The multi-cloud fabric further includes a controller that is in communication with resources of a cloud. The controller is responsive to the received one or more applications and includes a processor operable to analyze the same relative to the resources of the cloud to cause delivery of the one or more applications to the resources dynamically and automatically.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a data center 100, in accordance with an embodiment of the invention.

FIG. 2 shows further details of relevant portions of the data center 100 and in particular, the fabric 106 of FIG. 1.

FIG. 3 shows conceptually various features of the data center 300, in accordance with an embodiment of the invention.

FIG. 4 shows, in conceptual form, relevant portion of a multi-cloud data center 400, in accordance with another embodiment of the invention.

FIGS. 4a-c show exemplary data centers configured using embodiments and methods of the invention.

FIG. 5 shows, in conceptual form, relevant portion of a multi-cloud data center 500, in accordance with another embodiment of the invention.

FIG. 6 shows an exemplary communication in a multi-cloud data center 600, in accordance with another embodiment of the invention.

FIG. 7 shows another exemplary communication in a multi-cloud data center 600, in accordance with another embodiment of the invention.

FIG. 8 shows flow charts of the relevant steps 800 performed by a multi-cloud fabric controller, in accordance with various methods of the invention.

FIG. 9 shows flow charts of the relevant steps 900 performed by the cloud controller or cloud engine to perform affinity algorithm, in accordance with various methods of the invention.

FIG. 10 shows flow charts of the relevant steps 1000 performed by the cloud controller or cloud engine to identify the cloud to launch instance algorithm, in accordance with various methods of the invention.

FIG. 11 shows flow charts of the relevant steps 1100 performed by the cloud profile manager, in accordance with various methods of the invention.

### DETAILED DESCRIPTION OF EMBODIMENTS

The following description describes a multi-cloud fabric. The multi-cloud fabric has a controller and spans homogeneously and seamlessly across the same or different types of clouds, as discussed below.

Particular embodiments and methods of the invention disclose a virtual multi-cloud fabric. Still other embodiments and methods disclose automation of application delivery by use of the multi-cloud fabric.

In other embodiments, a data center includes a plug-in, application layer, multi-cloud fabric, network, and one or more the same or different types of clouds.

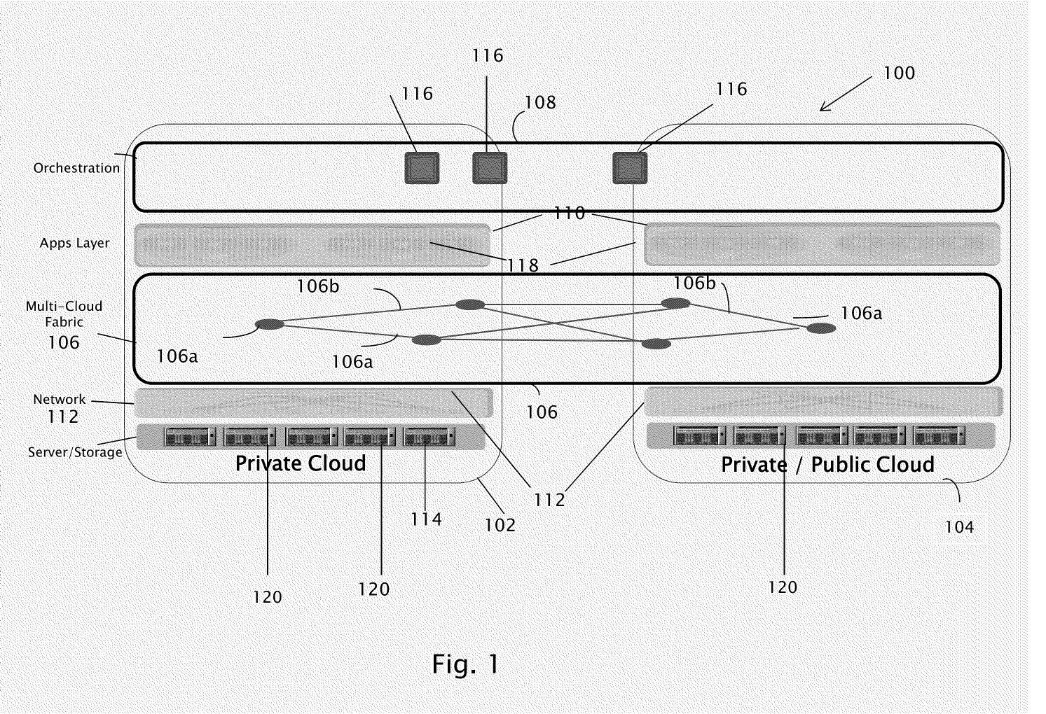

Referring now to FIG. 1, a data center 100 is shown, in accordance with an embodiment of the invention. The data center 100 is shown to include a private cloud 102 and a hybrid cloud 104. A hybrid cloud is a combination public and private cloud. The data center 100 is further shown to include a plug-in unit 108 and an multi-cloud fabric 106 spanning across the clouds 102 and 104. Each of the clouds 102 and 104 are shown to include a respective application layer 110, a network 112, and resources 114.

The network 112 includes switches and the like and the resources 114 are router, servers, and other networking and/or storage equipment.

The application layers 110 are each shown to include applications 118 and the resources 114 further include machines, such as servers, storage systems, switches, servers, routers, or any combination thereof.

The plug-in unit 108 is shown to include various plug-ins. As an example, in the embodiment of FIG. 1, the plug-in unit 108 is shown to include several distinct plug-ins 116, such as one made by Opensource, another made by Microsoft, Inc., and yet another made by VMware, Inc. Each of the foregoing plug-ins typically have different formats. The plug-in unit 108 converts all of the various formats of the applications into one or more native-format application for use by the multi-cloud fabric 106. The native-format application(s) is passed through the application layer 110 to the multi-cloud fabric 106.

The multi-cloud fabric 106 is shown to include various nodes 106a and links 106b connected together in a weave-like fashion.

In some embodiments of the invention, the plug-in unit 108 and the multi-cloud fabric 106 do not span across clouds and the data center 100 includes a single cloud. In embodiments with the plug-in unit 108 and multi-cloud fabric 106 spanning across clouds, such as that of FIG. 1, resources of the two clouds 102 and 104 are treated as resources of a single unit. For example, an application may be distributed across the resources of both clouds 102 and 104 homogeneously thereby making the clouds seamless. This allows use of analytics, searches, monitoring, reporting, displaying and otherwise data crunching thereby optimizing services and use of resources of clouds 102 and 104 collectively.

While two clouds are shown in the embodiment of FIG. 1, it is understood that any number of clouds, including one cloud, may be employed. Furthermore, any combination of private, public and hybrid clouds may be employed. Alternatively, one or more of the same type of cloud may be employed.

In an embodiment of the invention, the multi-cloud fabric 106 is a Layer (L) 4-7 fabric. Those skilled in the art appreciate data centers with various layers of networking. As earlier noted, Multi-cloud fabric 106 is made of nodes 106a and connections (or “links”) 106b. In an embodiment of the invention, the nodes 106a are devices, such as but not limited to L4-L7 devices. In some embodiments, the multi-cloud fabric 106 is implemented in software and in other embodiments, it is made with hardware and in still others, it is made with hardware and software.

The multi-cloud fabric 106 sends the application to the resources 114 through the networks 112.

In an SLA engine, as will be discussed relative to a subsequent figure, data is acted upon in real-time. Further, the data center 100 dynamically and automatically delivers applications, virtually or in physical reality, in a single or multi-cloud of either the same or different types of clouds.

The data center 100, in accordance with some embodiments and methods of the invention, serves as a service (Software as a Service (SAAS) model, a software package through existing cloud management platforms, or a physical appliance for high scale requirements. Further, licensing can be throughput or flow-based and can be enabled with network services only, network services with SLA and elasticity engine (as will be further evident below), network service enablement engine, and/or multi-cloud engine.

As will be further discussed below, the data center 100 may be driven by representational state transfer (REST) application programming interface (API).

The data center 100, with the use of the multi-cloud fabric 106, eliminates the need for an expensive infrastructure, manual and static configuration of resources, limitation of a single cloud, and delays in configuring the resources, among other advantages. Rather than a team of professionals configuring the resources for delivery of applications over months of time, the data center 100 automatically and dynamically does the same, in real-time. Additionally, more features and capabilities are realized with the data center 100 over that of prior art. For example, due to multi-cloud and virtual delivery capabilities, cloud bursting to existing clouds is possible and utilized only when required to save resources and therefore expenses.

Moreover, the data center 100 effectively has a feedback loop in the sense that results from monitoring traffic, performance, usage, time, resource limitations and the like, i.e. the configuration of the resources can be dynamically altered based on the monitored information. A log of information pertaining to configuration, resources, the environment, and the like allow the data center 100 to provide a user with pertinent information to enable the user to adjust and substantially optimize its usage of resources and clouds. Similarly, the data center 100 itself can optimize resources based on the foregoing information.

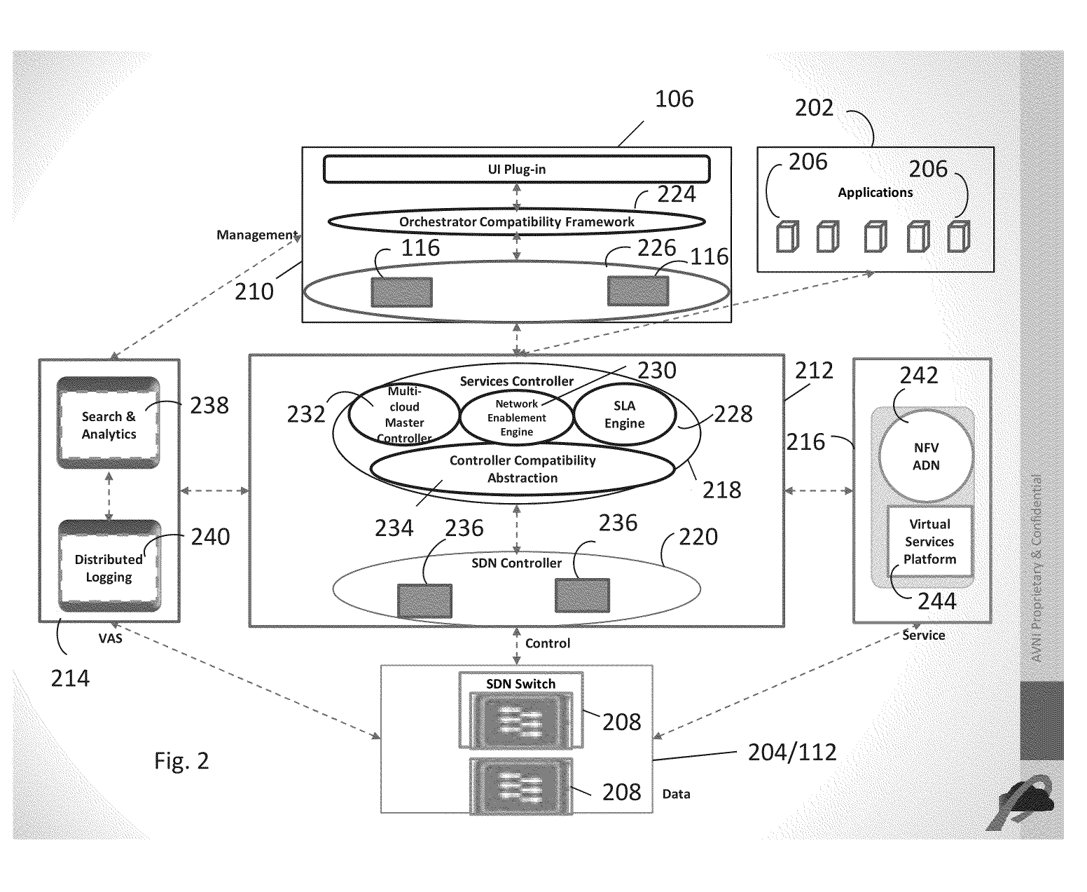

FIG. 2 shows further details of relevant portions of the data center 100 and in particular, the fabric 106 of FIG. 1. The fabric 106 is shown to be in communication with a applications unit 202 and a network 204, which is shown to include a number of Software Defined Networking (SDN)-enabled controllers and switches 208. The network 204 is analogous to the network 112 of FIG. 1.

The applications unit 202 is shown to include a number of applications 206, for instance, for an enterprise. These applications are analyzed, monitored, searched, and otherwise crunched just like the applications from the plug-ins of the fabric 106 for ultimate delivery to resources through the network 204.

The data center 100 is shown to include five units (or planes), the management unit 210, the value-added services (VAS) unit 214, the controller unit 212, the service unit 216 and the data unit (or network) 204. Accordingly and advantageously, control, data, VAS, network services and management are provided separately. Each of the planes is an agent and the data from each of the agents is crunched by the controller 212 and the VAS unit 214.

The fabric 106 is shown to include the management unit 210, the VAS unit 214, the controller unit 212 and the service unit 216. The management unit 210 is shown to include a user interface (UI) plug-in 222, an orchestrator compatibility framework 224, and applications 226. The management unit 210 is analogous to the plug-in 108. The UI plug-in 222 and the applications 226 receive applications of various formats and the framework 224 translates the various formatted application into native-format applications. Examples of plug-ins 116, located in the applications 226, are VMware ICenter, by VMware, Inc. and System Center by Microsoft, Inc. While two plug-ins are shown in FIG. 2, it is understood that any number may be employed.

The controller unit (also referred to herein as “multi-cloud master controller”) 212 serves as the master or brain of the data center 100 in that it controls the flow of data throughout the data center and timing of various events, to name a couple of many other functions it performs as the mastermind of the data center. It is shown to include a services controller 218 and a SDN controller 220. The services controller 218 is shown to include a multi-cloud master controller 232, an application delivery services stitching engine or network enablement engine 230, a SLA engine 228, and a controller compatibility abstraction 234.

Typically, one of the clouds of a multi-cloud network is the master of the clouds and includes a multi-cloud master controller that talks to local cloud controllers (or managers) to help configure the topology among other functions. The master cloud includes the SLA engine 228 whereas other clouds need not to but all clouds include a SLA agent and a SLA aggregator with the former typically being a part of the virtual services platform 244 and the latter being a part of the search and analytics 238.

The controller compatibility abstraction 234 provides abstraction to enable handling of different types of controllers (SDN controllers) in a uniform manner to offload traffic in the switches and routers of the network 204. This increases response time and performance as well as allowing more efficient use of the network.

The network enablement engine 230 performs stitching where an application or network services (such as configuring load balance) is automatically enabled. This eliminates the need for the user to work on meeting, for instance, a load balance policy. Moreover, it allows scaling out automatically when violating a policy.

The flex cloud engine 232 handles multi-cloud configurations such as determining, for instance, which cloud is less costly, or whether an application must go onto more than one cloud based on a particular policy, or the number and type of cloud that is best suited for a particular scenario.

The SLA engine 228 monitors various parameters in real-time and decides if policies are met. Exemplary parameters include different types of SLAs and application parameters. Examples of different types of SLAs include network SLAs and application SLAs. The SLA engine 228, besides monitoring allows for acting on the data, such as service plane (L4-L7), application, network data and the like, in real-time.

The practice of service assurance enables Data Centers (DCs) and (or) Cloud Service Providers (CSPs) to identify faults in the network and resolve these issues in a timely manner so as to minimize service downtime. The practice also includes policies and processes to proactively pinpoint, diagnose and resolve service quality degradations or device malfunctions before subscribers (users) are impacted.

Service assurance encompasses the following:
Fault and event management
   Performance management
   Probe monitoring
   Quality of service (QoS) management
   Network and service testing
   Network traffic management
   Customer experience management
   Real-time SLA monitoring and assurance
   Service and Application availability
   Trouble ticket management

The structures shown included in the controller unit 212 are implemented using one or more processors executing software (or code) and in this sense, the controller unit 212 may be a processor. Alternatively, any other structures in FIG. 2 may be implemented as one or more processors executing software. In other embodiments, the controller unit 212 and perhaps some or all of the remaining structures of FIG. 2 may be implemented in hardware or a combination of hardware and software.

VAS unit 214 uses its search and analytics unit 238 to search analytics based on distributed large data engine and crunches data and displays analytics. The search and analytics unit 238 can filter all of the logs the distributed logging unit 240 of the VAS unit 214 logs, based on the customer's (user's) desires. Examples of analytics include events and logs. The VAS unit 214 also determines configurations such as who needs SLA, who is violating SLA, and the like.

The SDN controller 220, which includes software defined network programmability, such as those made by Floodligh, Open Daylight, PDX, and other manufacturers, receives all the data from the network 204 and allows for programmability of a network switch/router.

The service plane 216 is shown to include an API based, Network Function Virtualization (NFV), Application Delivery Network (ADN) 242 and on a Distributed virtual services platform 244. The service plane 216 activates the right components based on rules. It includes ADC, web-application firewall, DPI, VPN, DNS and other L4-L7 services and configures based on policy (it is completely distributed). It can also include any application or L4-L7 network services.

The distributed virtual services platform contains an Application Delivery Controller (ADC), Web Application Firewall (Firewall), L2-L3 Zonal Firewall (ZFW), Virtual Private Network (VPN), Deep Packet Inspection (DPI), and various other services that can be enabled as a single-pass architecture. The service plane contains a Configuration agent, Stats/Analytics reporting agent, Zero-copy driver to send and receive packets in a fast manner, Memory mapping engine that maps memory via TLB to any virtualized platform/hypervisor, SSL offload engine, etc.

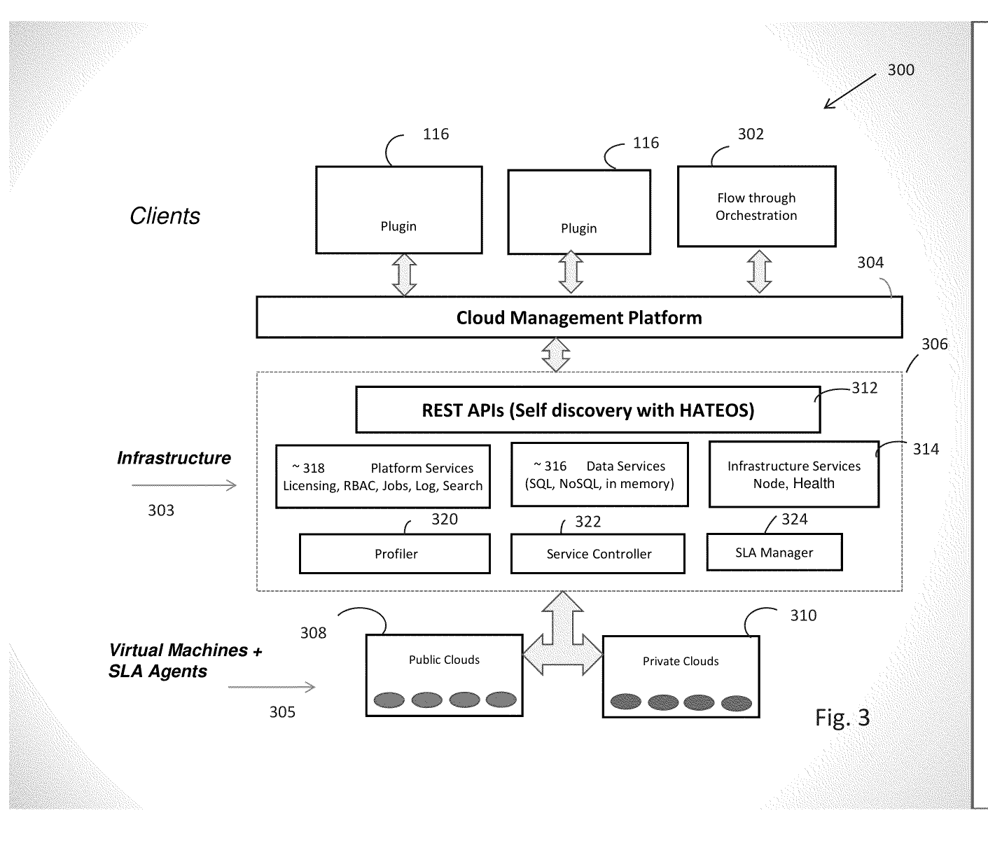

FIG. 3 shows conceptually various features of the data center 300, in accordance with an embodiment of the invention. The data center 300 is analogous to the data center 100 except some of the features/structures of the data center 300 are in addition to those shown in the data center 100. The data center 300 is shown to include plug-ins 116, flow-through orchestration 302, cloud management platform 304, controller 306, and public and private clouds 308 and 310, respectively.

The controller 306 is analogous to the controller 212 of FIG. 2. In FIG. 3, the controller 306 is shown to include a REST APIs-based invocations for self-discovery, platform services 318, data services 316, infrastructure services 314, profiler 320, service controller 322, and SLA manager 324.

The flow-through orchestration 302 is analogous to the framework 224 of FIG. 2. Plug-ins 116 and orchestration 302 provide applications to the cloud management platform 304, which converts the formats of the applications to native format. The native-formatted applications are processed by the controller 306, which is analogous to the controller 212 of FIG. 2. The RESI APIs 312 drive the controller 306. The platform services 318 is for services such as licensing, Role Based Access and Control (RBAC), jobs, log, and search. The data services 316 is to store data of various components, services, applications, databases such as Search and Query Language (SQL), NoSQL, data in memory. The infrastructure services 314 is for services such as node and health.

The profiler 320 is a test engine. Service controller 322 is analogous to the controller 220 and SLA manager 324 is analogous to the SLA engine 228 of FIG. 2. During testing by the profiler 320, simulated traffic is run through the data center 300 to test for proper operability as well as adjustment of parameters such as response time, resource and cloud requirements, and processing usage.

In the exemplary embodiment of FIG. 3, the controller 306 interacts with public clouds 308 and private clouds 310. Each of the clouds 308 and 310 include multiple clouds and communicate not only with the controller 306 but also with each other. Benefits of the clouds communicating with one another is optimization of traffic path, dynamic traffic steering, and/or reduction of costs, among perhaps others.

The plug-ins 116 and the flow-through orchestration 302 are the clients 310 of the data center 300, the controller 306 is the infrastructure of the data center 300, and the clouds 308 and 310 are the virtual machines and SLA agents 305 of the data center 300.

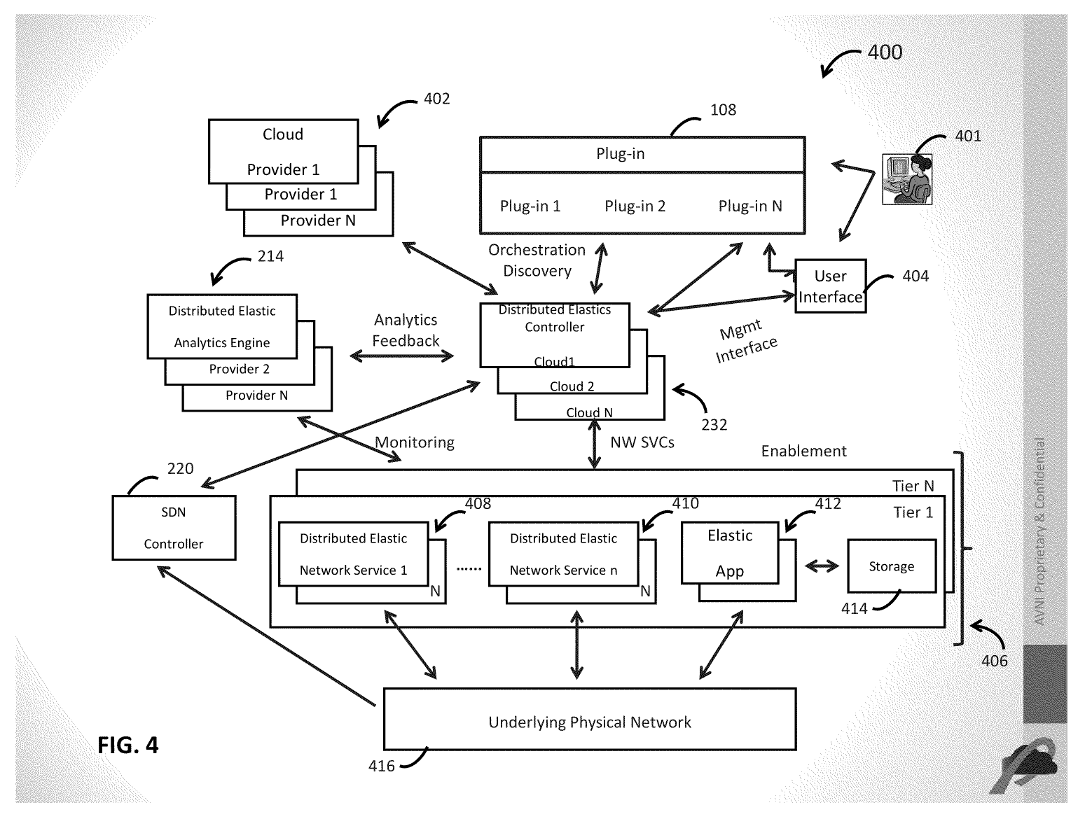

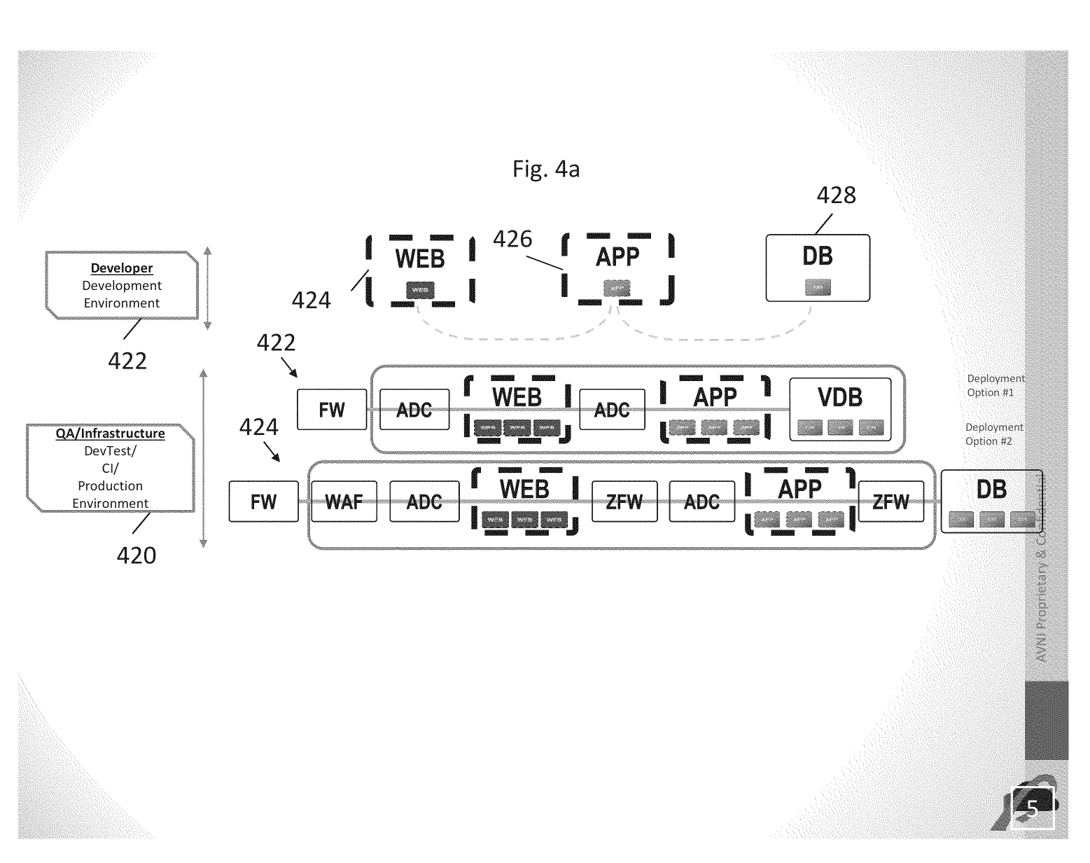

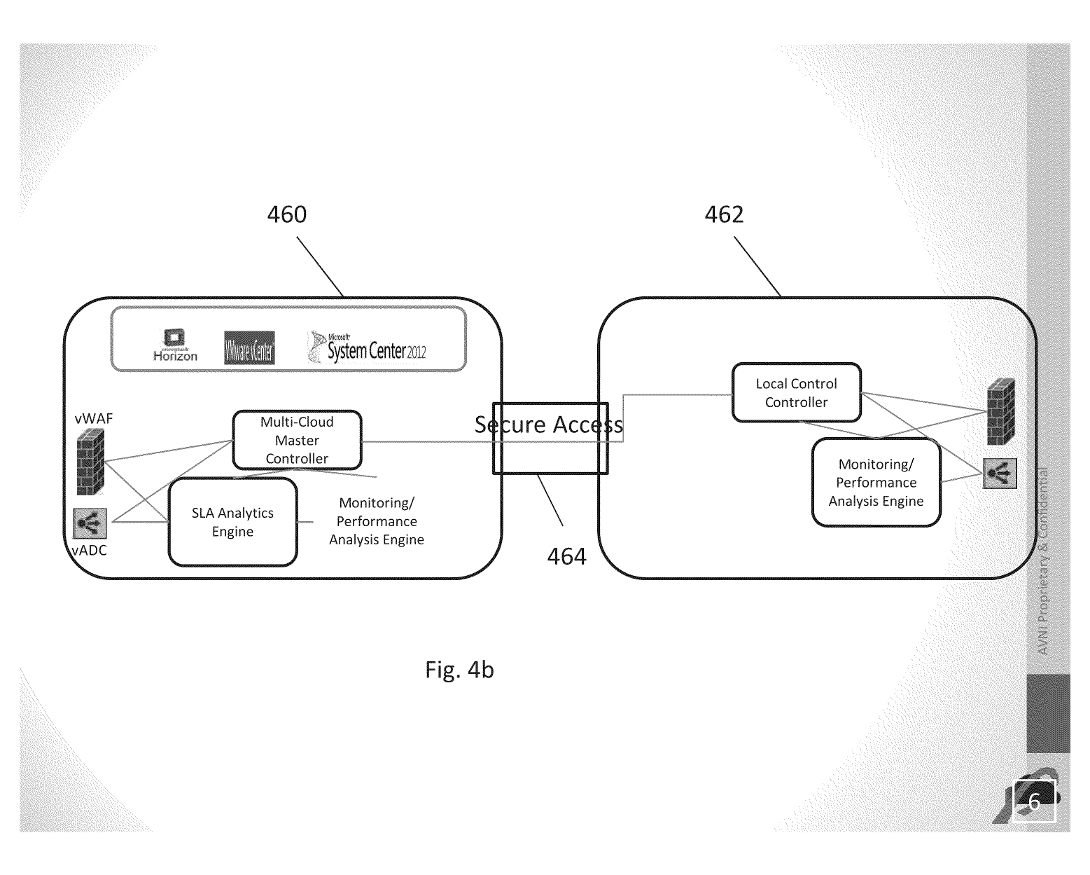

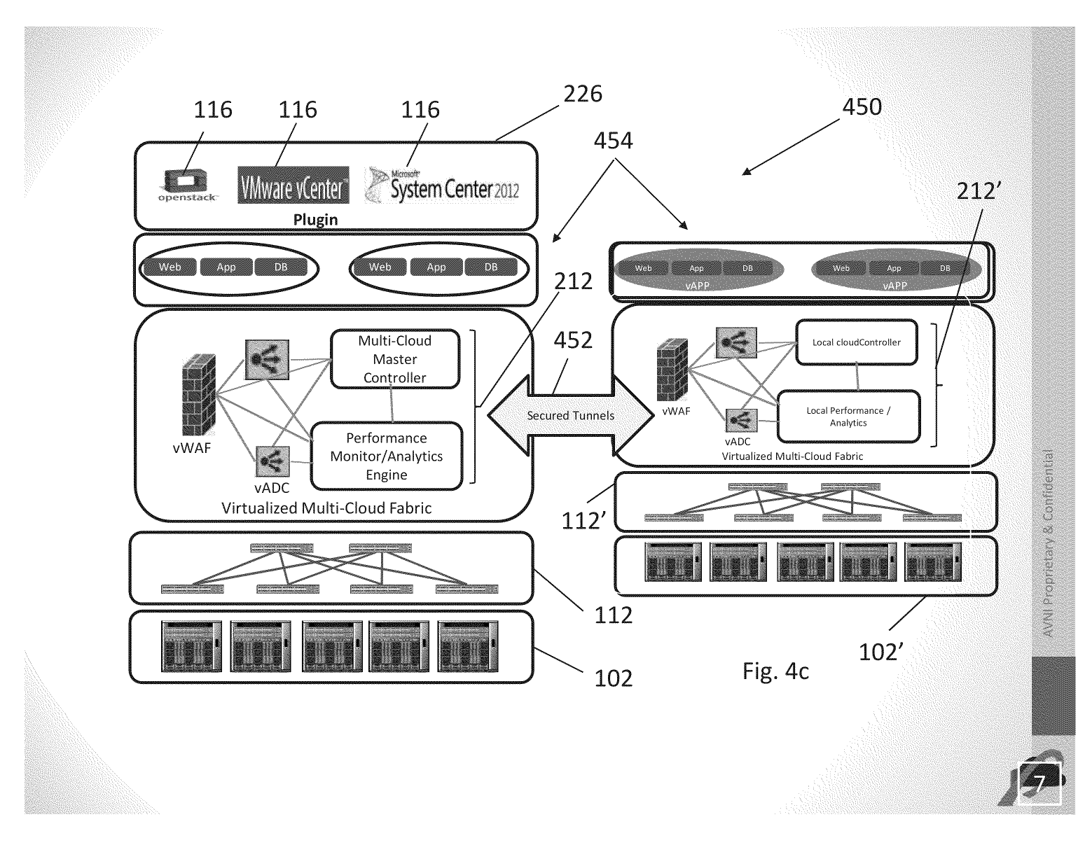

FIG. 4 shows, in conceptual form, relevant portion of a multi-cloud data center 400, in accordance with another embodiment of the invention. A client (or user) 401 is shown to use the data center 400, which is shown to include plug-in units 108, cloud providers 1-N 402, distributed elastic analytics engine (or “VAS unit”) 214, distributed elastic controller (of clouds 1-N) (also known herein as “flex cloud engine” or “multi-cloud master controller”) 232, tiers 1-N, underlying physical NW 416, such as Servers, Storage, Network elements, etc. and SDN controller 220.

Each of the tiers 1-N is shown to include distributed elastic 1-N, 408-410, respectively, elastic applications 412, and storage 414. The distributed elastic 1-N 408-410 and elastic applications 412 communicate bidirectional with the underlying physical NW 416 and the latter unilaterally provides information to the SDN controller 220. A part of each of the tiers 1-N are included in the service plane 216 of FIG. 2.

The cloud providers 402 are providers of the clouds shown and/or discussed herein. The distributed elastic controllers 1-N each service a cloud from the cloud providers 402, as discussed previously except that in FIG. 4, there are N number of clouds, “N” being an integer value.

As previously discussed, the distributed elastic analytics engine 214 includes multiple VAS units, one for each of the clouds, and the analytics are provided to the controller 232 for various reasons, one of which is the feedback feature discussed earlier. The controllers 232 also provide information to the engine 214, as discussed above.

The distributed elastic services 1-N are analogous to the services 318, 316, and 314 of FIG. 3 except that in FIG. 4, the services are shown to be distributed, as are the controllers 232 and the distributed elastic analytics engine 214. Such distribution allows flexibility in the use of resource allocation therefore minimizing costs to the user among other advantages.

The underlying physical NW 416 is analogous to the resources 114 of FIG. 1 and that of other figures herein. The underlying network and resources include servers for running any applications, storage, network elements such as routers, switches, etc. The storage 414 is also a part of the resources.

The tiers 406 are deployed across multiple clouds and are enablement. Enablement refers to evaluation of applications for L4 through L7. An example of enablement is stitching.

In summary, the data center of an embodiment of the invention, is multi-cloud and capable of application deployment, application orchestration, and application delivery.

In operation, the user (or “client”) 401 interacts with the UI 404 and through the UI 404, with the plug-in unit 108. Alternatively, the user 401 interacts directly with the plug-in unit 108. The plug-in unit 108 receives applications from the user with perhaps certain specifications. Orchestration and discover take place between the plug-in unit 108, the controllers 232 and between the providers 402 and the controllers 232. A management interface (also known herein as “management unit” 210) manages the interactions between the controllers 232 and the plug-in unit 108.

The distributed elastic analytics engine 214 and the tiers 406 perform monitoring of various applications, application delivery services and network elements and the controllers 232 effectuate service change.

In accordance with various embodiments and methods of the invention, some of which are shown and discussed herein, an Multi-cloud fabric is disclosed. The Multi-cloud fabric includes an application management unit responsive to one or more applications from an application layer. The Multi-cloud fabric further includes a controller in communication with resources of a cloud, the controller is responsive to the received application and includes a processor operable to analyze the received application relative to the resources to cause delivery of the one or more applications to the resources dynamically and automatically.

The multi-cloud fabric, in some embodiments of the invention, is virtual. In some embodiments of the invention, the multi-cloud fabric is operable to deploy the one or more native-format applications automatically and/or dynamically. In still other embodiments of the invention, the controller is in communication with resources of more than one cloud.

The processor of the multi-cloud fabric is operable to analyze applications relative to resources of more than one cloud.

In an embodiment of the invention, the Value Added Services (VAS) unit is in communication with the controller and the application management unit and the VAS unit is operable to provide analytics to the controller. The VAS unit is operable to perform a search of data provided by the controller and filters the searched data based on the user's specifications (or desire).

In an embodiment of the invention, the Multi-cloud fabric includes a service unit that is in communication with the controller and operative to configure data of a network based on rules from the user or otherwise.

In some embodiments, the controller includes a cloud engine that assesses multiple clouds relative to an application and resources. In an embodiment of the invention, the controller includes a network enablement engine.

In some embodiments of the invention, the application deployment fabric includes a plug-in unit responsive to applications with different format applications and operable to convert the different format applications to a native-format application. The application deployment fabric can report configuration and analytics related to the resources to the user. The application deployment fabric can have multiple clouds including one or more private clouds, one or more public clouds, or one or more hybrid clouds. A hybrid cloud is private and public.

The application deployment fabric configures the resources and monitors traffic of the resources, in real-time, and based at least on the monitored traffic, re-configure the resources, in real-time.

In an embodiment of the invention, the Multi-cloud fabric can stitch end-to-end, i.e. an application to the cloud, automatically.

In an embodiment of the invention, the SLA engine of the Multi-cloud fabric sets the parameters of different types of SLA in real-time.

In some embodiments, the Multi-cloud fabric automatically scales in or scales out the resources. For example, upon an underestimation of resources or unforeseen circumstances requiring addition resources, such as during a super bowl game with subscribers exceeding an estimated and planned for number, the resources are scaled out and perhaps use existing resources, such as those offered by Amazon, Inc. Similarly, resources can be scaled down.

The following are some, but not all, various alternative embodiments. The Multi-cloud fabric is operable to stitch across the cloud and at least one more cloud and to stitch network services, in real-time.

The multi-cloud fabric is operable to burst across clouds other than the cloud and access existing resources.

The controller of the Multi-cloud fabric receives test traffic and configures resources based on the test traffic.

Upon violation of a policy, the Multi-cloud fabric automatically scales the resources.

The SLA engine of the controller monitors parameters of different types of SLA in real-time.

The SLA includes application SLA and networking SLA, among other types of SLA contemplated by those skilled in the art.

The Multi-cloud fabric may be distributed and it may be capable of receiving more than one application with different formats and to generate native-format applications from the more than one application.

The resources may include storage systems, servers, routers, switches, or any combination thereof.

The analytics of the Multi-cloud fabric include but not limited to traffic, response time, connections/sec, throughput, network characteristics, disk I/O or any combination thereof.

In accordance with various alternative methods, of delivering an application by the multi-cloud fabric, the multi-cloud fabric receives at least one application, determines resources of one or more clouds, and automatically and dynamically delivers the at least one application to the one or more clouds based on the determined resources. Analytics related to the resources are displayed on a dashboard or otherwise and the analytics help cause the Multi-cloud fabric to substantially optimally deliver the at least one application.

FIGS. 4a-c show exemplary data centers configured using embodiments and methods of the invention. FIG. 4a shows the example of a work flow of a 3-tier application development and deployment. At 422 is shown a developer's development environment including a web tier 424, an application tier 426 and a database 428, each used by a user for different purposes typically and perhaps requiring its own security measure. For example, a company like Yahoo, Inc. may use the web tier 424 for its web and the application tier 426 for its applications and the database 428 for its sensitive data. Accordingly, the database 428 may be a part of a private rather than a public cloud. The tiers 424 and 426 and database 420 are all linked together.

At 420, development testing and production environment is shown. At 422, an optional deployment is shown with a firewall (FW), ADC, a web tier (such as the tier 404), another ADC, an application tier (such as the tier 406), and a virtual database (same as the database 428). ADC is essentially a load balancer. This deployment may not be optimal and actually far from it because it is an initial pass and without the use of some of the optimizations done by various methods and embodiments of the invention. The instances of this deployment are stitched together (or orchestrated).

At 424, another optional deployment is shown with perhaps greater optimization. A FW is followed by a web-application FW (WFW), which is followed by an ADC and so on. Accordingly, the instances shown at 424 are stitched together.

Accordingly, consistent development/production environments are realized. Automated discovery, automatic stitching, test and verify, real-time SLA, automatic scaling up/down capabilities of the various methods and embodiments of the invention may be employed for the three-tier (web, application, and database) application development and deployment of FIG. 4a. Further, deployment can be done in minutes due to automation and other features. Deployment can be to a private cloud, public cloud, or a hybrid cloud or multi-clouds.

FIG. 4b shows an exemplary multi-cloud having a public, private, or hybrid cloud 460 and another public or private or hybrid cloud 464 communication through a secure access 464. The cloud 460 is shown to include the master controller whereas the cloud 462 is the slave or local cloud controller. Accordingly, the SLA engine resides in the cloud 460.

FIG. 4c shows a virtualized multi-cloud fabric spanning across multiple clouds with a single point of control and management.

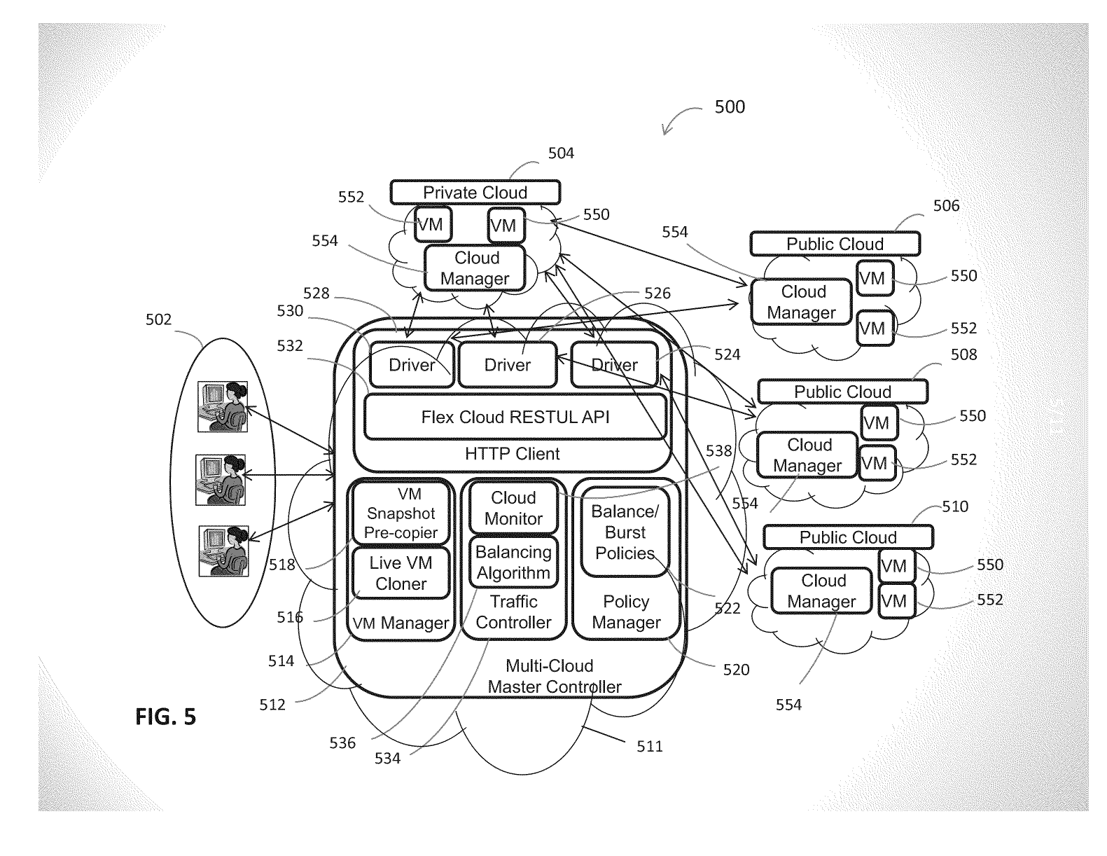

FIG. 5 shows, in conceptual form, relevant portion of a multi-cloud data center 500, in accordance with another embodiment of the invention. The data center 500 is analogous to the data center 100 of FIG. 1 and the data center 400 of FIG. 4. Clients (or users) 502 are shown to use the data center 500. Any of the clients 502 are analogous to the client 401 of FIG. 4.

The data center 500 is shown to include private cloud 504, public clouds 506, 508 and 510, and a multi-cloud master controller 512. The multi-cloud master controller 512 is analogous to the multi-cloud master controller 232. The multi-cloud master controller 512 manages and sees to multi-cloud configurations such as determining which cloud is less costly, or whether an application must be distributed across more than one cloud based on some criteria, such as a particular policy, or the number and type of clouds best suited for a particular multi-cloud scenario.

The multi-cloud master controller 512 is shown to include virtual machine (VM) manager 514, traffic controller 534, policy manager 520, and Traffic generation client 528. The VM manager 514 is further shown to include VM snapshot pre-copier 518 and live VM cloner 516. The traffic controller 534 is shown to include cloud monitor 538 and balancing algorithm 536. The policy manager 520 is shown to include balance/burst policies 522. The HTTP client 528 is shown to include multi-cloud representational state transfer (REST) application programmable interface (API) 532 and drivers 530, 526, and 524 corresponding to each of the public clouds 506, 508, and 510.

Each of the public clouds 506, 508, and 510 and the private cloud 504 is shown to include virtual machines 550 and 552 and a cloud manager 554. The multi-cloud master controller 512 is a part of cloud 511, which may be a public, private, or hybrid cloud. Among the clouds shown in FIG. 5, only one cloud, namely cloud 511 has a master controller. The remaining clouds, i.e. clouds 504 through 510, serve as slave controllers to the master controller. That is, the cloud manager 554 of each of the clouds 504 through 510 report to the master controller 512 and the master controller 512, in turn, sends the local cloud managers 554 information regarding topology, configuration, load, and other information relevant to a local cloud manager.

The public clouds 506, 508, and 510 are shown to be in communication with the respective drivers 530, 526, and 524. The public clouds 506, 508, and 510 are further shown to be in communication with the private cloud 504. The private cloud is further shown to be in communication with the drivers 528, 526, and 524. Examples of public clouds include Amazon's EC2, VMware's vCloud, and clouds made by Rackspace.

The policy manager 520 includes a burst and balancing policies 522 for cloud bursting and balancing policies. Cloud bursting occurs under various conditions, some of which are bursting to a public cloud from a private cloud for cost or other reasons, failure of a cloud and the like. Balancing of clouds relates to load balancing among clouds. All of the above, in addition to other master-brain types of activities are conducted by the master controller 512 and utilized to manage the remaining clouds. While such policies are kept in the burst and balancing policies 522, the algorithm used for balancing is done by the balancing algorithm 536 of the traffic controller 534. It should be noted that in addition to balancing across clouds, the master controller is also capable of balancing loads within a single cloud.

The VM manager 514, shown in FIG. 5 to include the VM snapshot 518 and live VM cloner 516, manage VMs. For example, the pre-copier 518 takes a snapshot of a cloud that is to be unemployed in the future for reasons such as but not limited to defects and cloud balancing. The VM cloner 516 then creates a clone or copy of the cloud using information from the pre-copier 518.

The flex cloud Representational State Transfer (REST) Application Programmable Interface (API) 532 performs functions, along with the drivers 524, 526, and 530, such as causing a cloud to be launched or sending cloud information received by the drivers to blocks shown in the controller 512 where they are supposed to go.

The controller 512 is analogous to the controller 212 with additional details shown. The drivers 524, 526, and 530 generally reside in the controller 306 or the cloud management platform 304, shown in FIG. 3.

In some embodiments of the invention, the master controller 512 launches several instances corresponding to a service or an application. All instances associated with service(s) and/or applications(s) can be launched to the same or more than one public, private or hybrid cloud. The master controller 512 analyzes the analytics against the SLA policies and scales up or scales down accordingly. As a part of scaling up, the master controller 512 launches one or more instances.

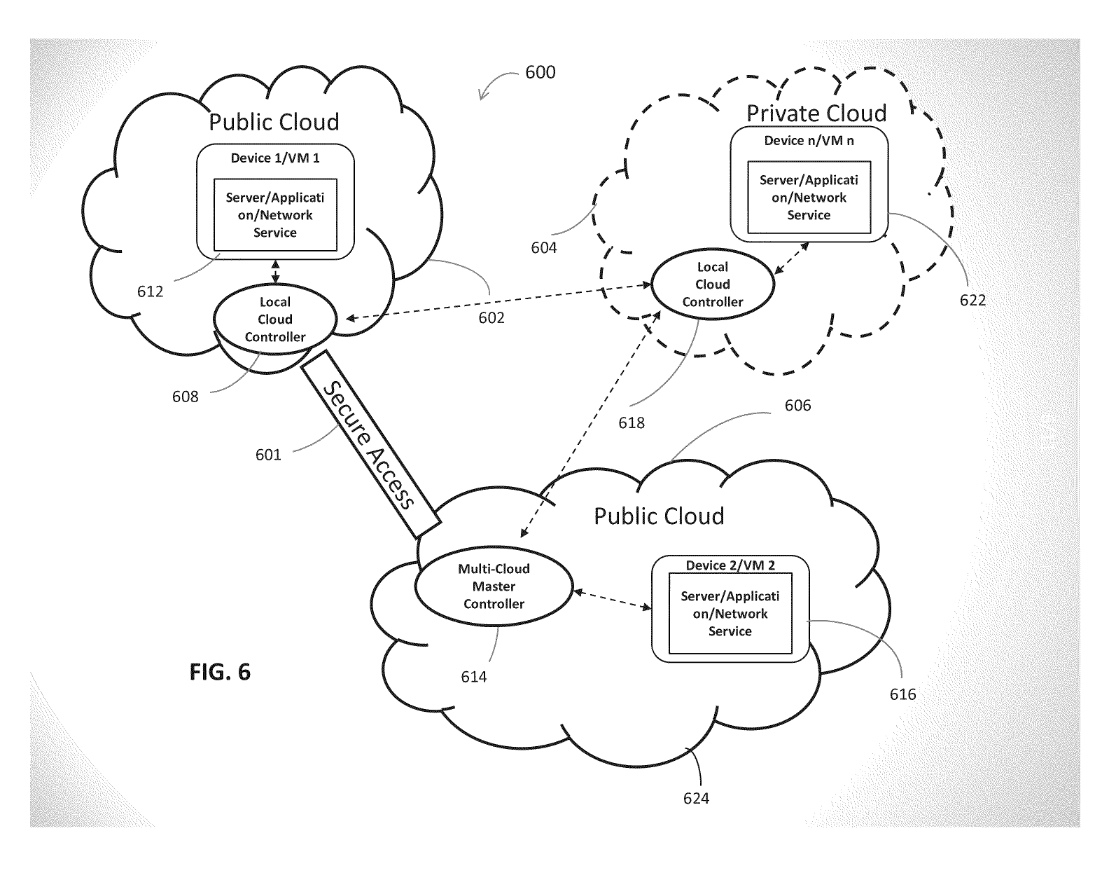

FIG. 6 shows an exemplary communication in a multi-cloud data center 600, in with another embodiment of the invention. The data center 600, which is analogous to any of the data centers shown and discussed herein, is shown to include public cloud 602 and 606 and private cloud 604. The public cloud 602 is shown to include device 1/VM1 612 and in communication with its local cloud controller 608. The private cloud 604 is shown to include a device n/VM n 618 and in communication with its local cloud controller 618. The public cloud 606 is shown to include device 2/VM2 616 and in communication with its multi-cloud master controller 614. The devices 1-n (612, 616, and 622) are shown distributed across clouds 602, 624, and 604, respectively. To reiterate, the fabric 106, shown in FIG. 1, allows for distribution among clouds.

The multi-cloud master controller 608 is analogous to the multi-master cloud controller 232 and the multi-master cloud controller 512.

The device 2/VM2 616 is shown to be in communication with multi-cloud master controller 614. The multi-cloud master controller 614 is further shown to be in communication with local cloud controller 618 of private cloud 604 and in secure communication with local cloud controller 608 of public cloud 602. Secure access 601 communication between clouds is done, for example, by using encryption/decryption with various known encoding/decoding algorithms. Also, virtual private network (VPN) is used in the secure access 601. Clearly, secure access 601 is beneficial in maintaining a higher level of security of information between clouds.

Examples of different public cloud include Amazon web services (AWS) and Rackspace. Examples of different private cloud include traditional data center, power-on-demand (POD) data center, and managed cloud.

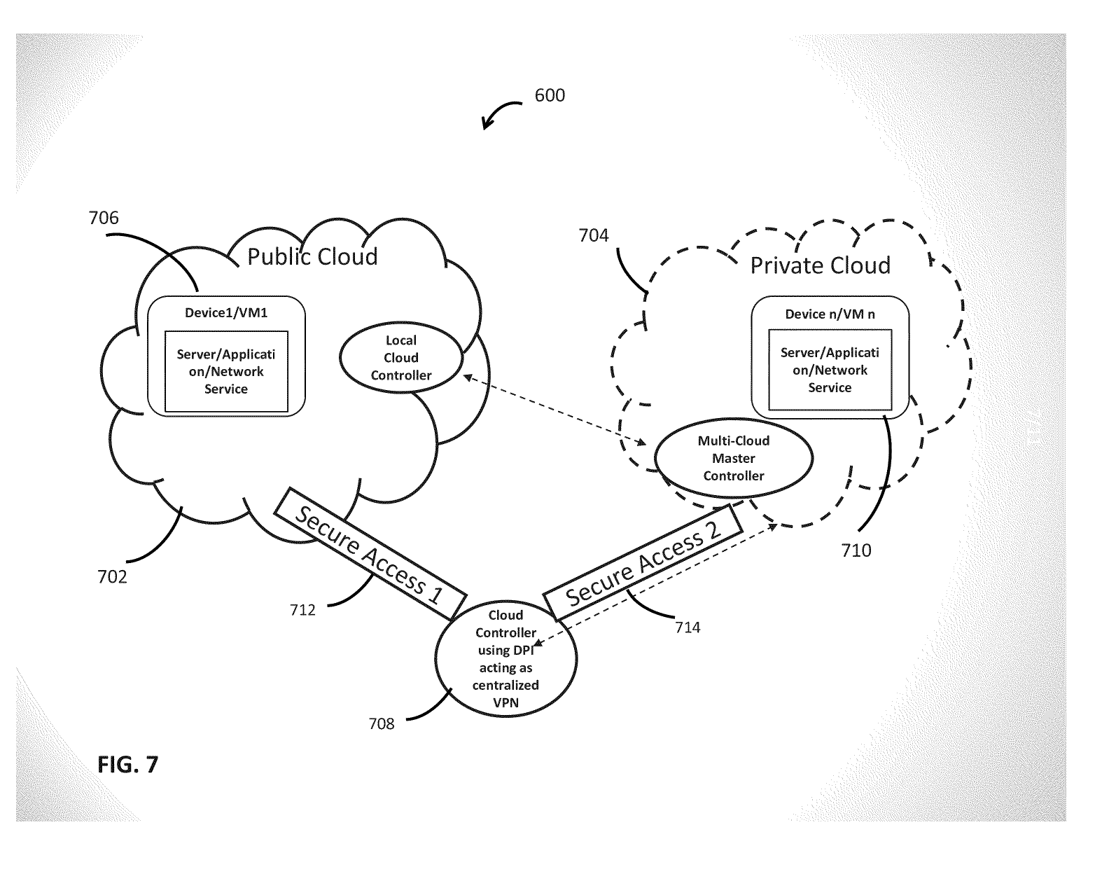

FIG. 7 shows another exemplary communication in a multi-cloud data center 600, in accordance with another embodiment of the invention. The data center 600, which is analogous to any of the data centers shown and discussed herein, is shown to include public cloud 702 and private cloud 704. The public cloud 702 is shown to include device 1/VM1 706 and in communication with the cloud controller 708 through a secure tunnel 1 712. The cloud controller 708 is analogous to the client engines 608 and 614 and the flex client engines 512 and 232. The private cloud 704 is shown to include device 1/VM 1 710 and in communication with the cloud controller 708 through a secure tunnel 2 714. The cloud controller 708 acts as a centralized VPN using deep packet inspection (DPI). VPN extends a private network across a public network and enables a computer to send and receive data across shared or public networks as if it was directly connected to the private network, while benefiting from the functionality, security, and management policies of the private network. DPI is a way to monitor the internet traffic to block the spread of viruses, identify illegal downloads, used in ways to alleviate network congestion.

Examples of different public clouds include Amazon web services (AWS) and Rackspace. Examples of different private cloud include traditional data center, performance-optimized data center (POD), and managed cloud.

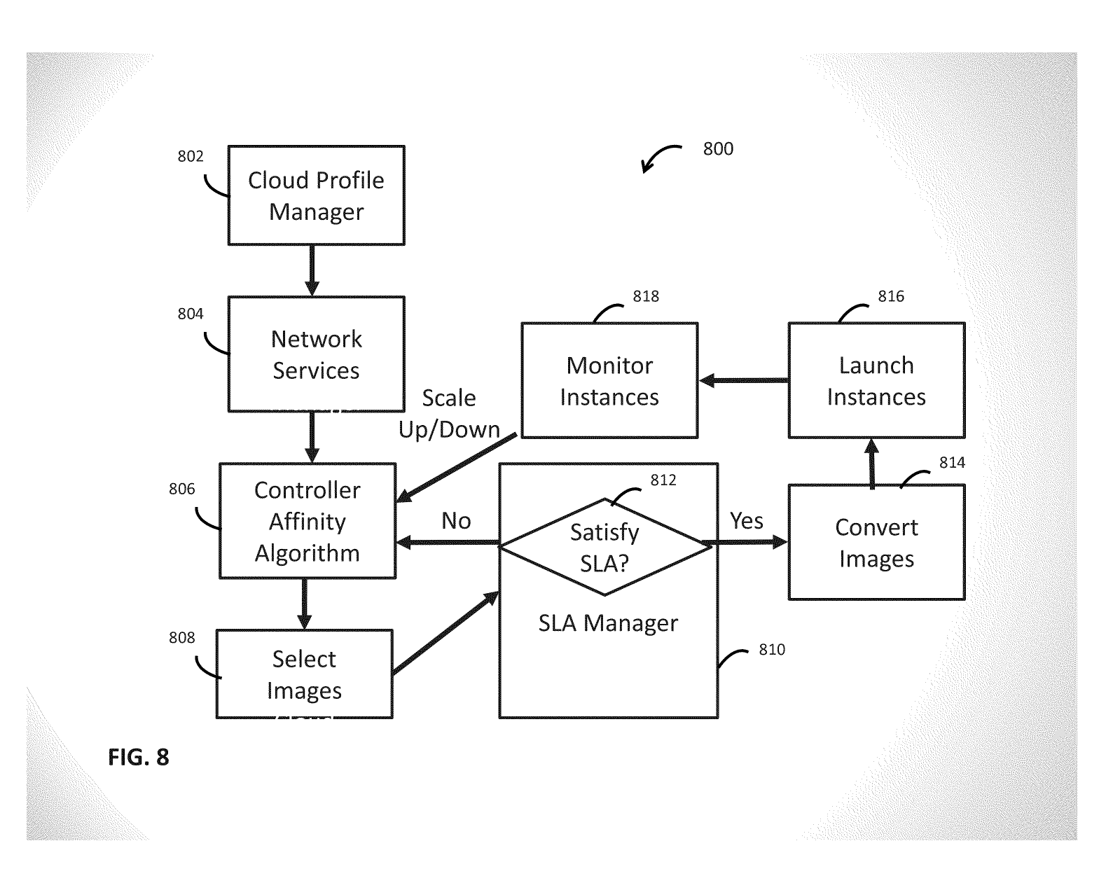

FIG. 8 shows flow charts of the relevant steps 800 performed by the master controller 512 of FIG. 5, in accordance with various methods of the invention. At step 802, the master controller fetches all the cloud profiles associated with the tenant performing the operation from the cloud profile manager 802. Cloud Profile Manager manages all the cloud profiles configured in the system on a per tenant basis and on a per cloud type basis. Cloud types could be Public, Private, Hybrid or specific subtypes of clouds such as VSphere, VCloud, AWS, Rackspace, Openstack. Next, at step 804, the master controller consults the Network Services Manager 804 and fetches all the network services that are to required and need to be deployed alongside the application that the tenant is deploying. And the process proceeds to step 806. At step 806, controller 512 performs affinity algorithm for choosing the most cost effective controller, from all the active controllers, that best serves the requirements of the application that is being deployed. Next at step 808, images are selected and the process proceeds to SLA manager at step 810. At 812, the SLA manager (or SLA engine) makes a determination as to whether or not the SLA policies are satisfied. If the SLA is not satisfied; “NO”, the process proceed to step 806 and repeats from thereon until SLA policies are met.

When the SLA policies are met “YES”, the process proceeds to step 814 where the selected images of step 808 are converted to a single format. For instance, each of the companies Amazon and Yahoo use their unique format for images, accordingly, a single format is done at step 814.

Next, at step 816, the controller 512 launches the instances and the process proceeds to step 818. At step 818, the controller monitors the launched instances for changes in the cloud, such as load change, and scales up or down accordingly and then proceeds to step 806 and continues from thereon.

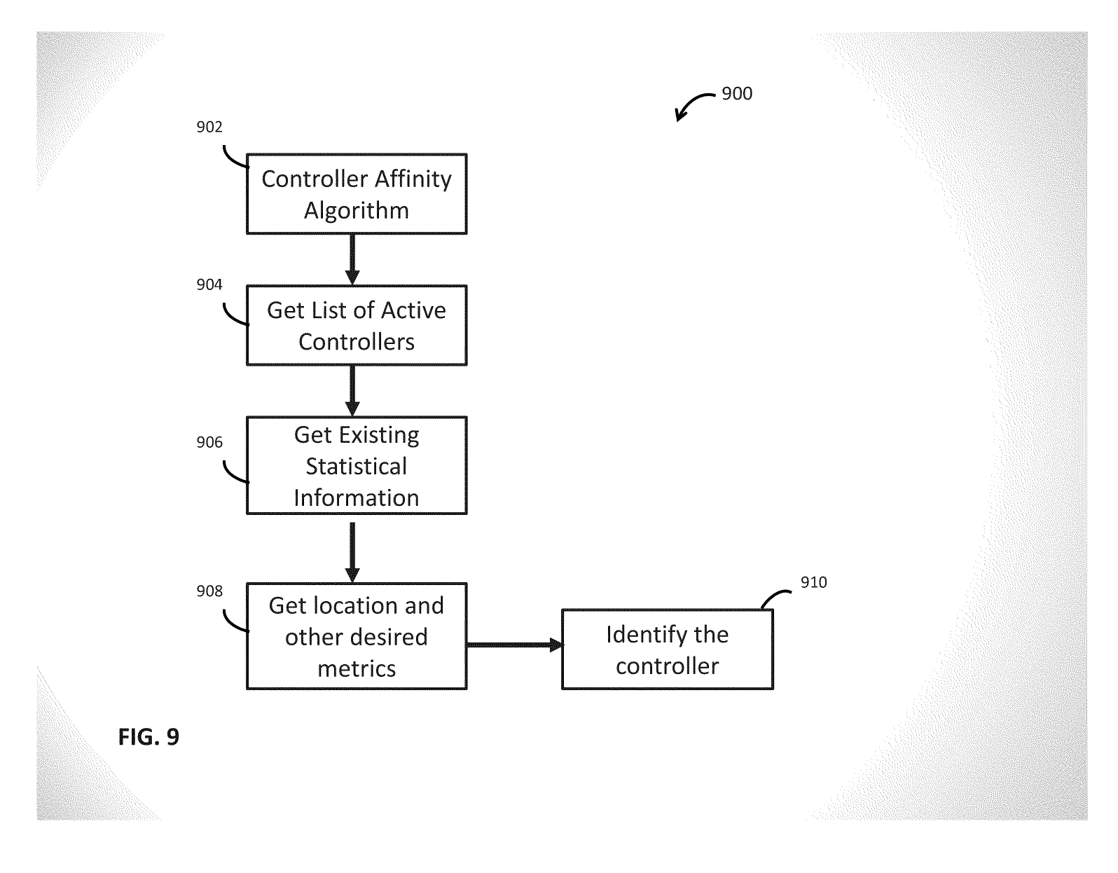

FIG. 9 shows a flow chart 900 of the relevant steps performed by the master controller 512, in accordance with an embodiment of the invention. At step 902, an affinity algorithm is executed. The affinity algorithm is the same as that used at step 806 of FIG. 8. Next at step 904, a list of active controllers is obtained. These controllers are cloud controllers and the master controller 512 is trying to get a tally of all clouds that are active or part of the multi-cloud by accruing a list of their respective cloud controller, which is done by communicating to each one, through a secure access or otherwise.

Next, the process proceeds to step 906 where the existing statistical information regarding each cloud is obtained. Next at step 908, location (or proximity) and other desired metrics, such as time-of-day among many others, is obtained and the process ends at step 910 where a controller of desire by the master controller 512 is identified.

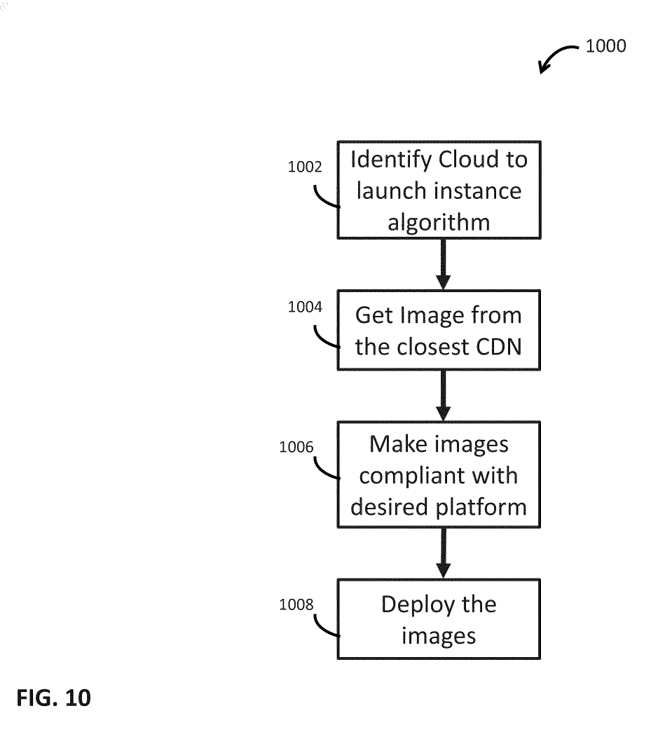

FIG. 10 shows a flow chart 1000 of the relevant steps performed by the master controller 512, in accordance with another method of the invention. At step 1002, a cloud to be launched using an instance algorithm is performed. Next at step 1004, images from the closest content delivery network (CDN) are obtained. The process proceeds to step 1006 where various images of different format are converted to become compliant with a predetermined and single format. Next at step 1008, the images are deployed to the desired platform or cloud and the process ends.

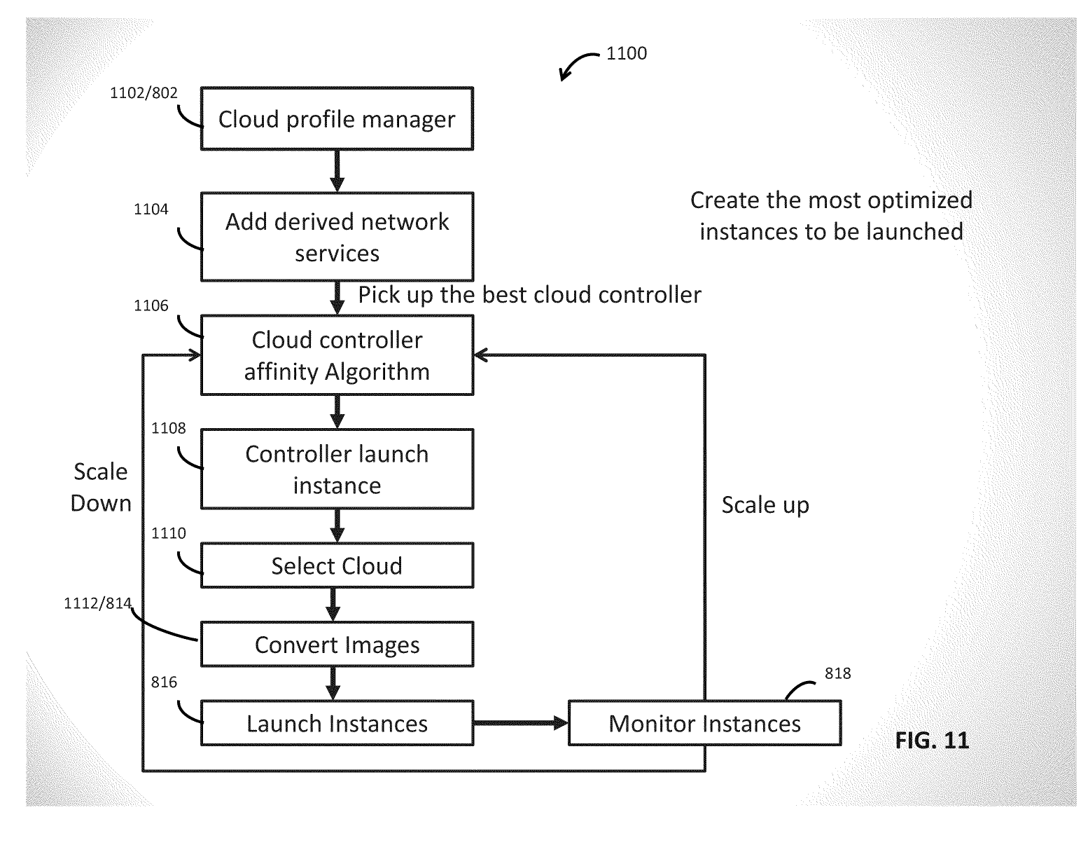

FIG. 11 shows a flow chart 1100 of the relevant steps performed by the cloud profile manager to scale up and/or, in accordance with various methods of the invention. The process is initiated at step 1102, which is the same as step 802 in FIG. 8, where a user picks up a cloud profile to be deployed. Next at step 1104, derived network services are added. Network Services are derived by consulting the Network Services Manager 804. The Network Services Manager derives the Network Services based on the various profiles configured by the tenant for the given application. After step 1104, the best local cloud controller is selected.

The process proceeds to step 1106 where the controller performs the affinity algorithm such as done at step 806, in FIG. 8. Next, at step 1108, the controller 512 launches an instance, such as done at step 816, in FIG. 8. Then, the process proceeds to step 1110 where a cloud compliant with the SLA policies is selected. Next, at step 1112, which is the same step as step 814, selected images are converted to the same format or the desired platform. Next at step 1114, which is the same as step 816, the instances are launched to the desired platform or cloud and the process continues to step 1116. At step 1116, the instances are monitored, as done in step 818, and scaling up or down is performed based on some criteria, such as load and availability of resources. After scaling up/down, the process continues to step 1106 and repeats from there.

Accordingly, substantially the most optimized instances are identified to be launched.

It is noted that the structures shown and discussed relative to the figures herein can be implemented using hardware or software or a combination thereof.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A multi-cloud fabric comprising:
a multi-cloud master controller of a first cloud being in communication with one or more other clouds through a respective local cloud controller, the multi-cloud master controller operable to dynamically and instantly deploy instances to the first cloud and the one or more other clouds.

2. The multi-cloud fabric of claim 1, wherein the multi-cloud fabric is further operable to convert applications or service images to an appropriate cloud format based on properties of the first cloud and the one or more other clouds.

3. The multi-cloud fabric of claim 1, wherein the first cloud and the one or more other clouds are of different types.

4. The multi-cloud fabric, as recited in claim 1, wherein a connection between one of the multiple clouds is secure.

5. The multi-cloud fabric, as recited in claim 1, wherein the multi-cloud fabric is physical.

6. The multi-cloud fabric, as recited in claim 1, wherein the multi-cloud fabric is made of hardware.

7. The multi-cloud fabric, as recited in claim 1, wherein the multi-cloud fabric is made of software.

8. The multi-cloud fabric, as recited in claim 1, wherein the multi-cloud fabric is made of hardware and software.

9. The multi-cloud fabric, as recited in claim 1, wherein the multi-cloud fabric is operable to deploy the one or more native-format applications automatically.

10. The multi-cloud fabric, as recited in claim 1, wherein applications are stitched.

11. The multi-cloud fabric, as recited in claim 1, operable to automatically stitch end-to-end.

12. The multi-cloud fabric, as recited in claim 1, wherein the multi-cloud fabric is operable to deploy the one or more native-format applications dynamically.

13. The multi-cloud fabric, as recited in claim 1, wherein the controller is in communication with resources of more than one cloud.

14. The multi-cloud fabric, as recited in claim 13, wherein the processor is further operable to analyze applications relative to resources of more than one cloud.

15. The multi-cloud fabric, as recited in claim 1, further including a value-added service (VAS) unit, the VAS unit being in communication with the controller and the application management unit and operable to provide analytics to the controller.

16. The multi-cloud fabric, as recited in claim 15, wherein the analytics include traffic, response time, connections/second, throughput, network characteristics, disk input/output, or any combination thereof.

17. The multi-cloud fabric, as recited in claim 16, wherein the VAS unit is operable to perform a search of data provided by the controller.

18. The multi-cloud fabric, as recited in claim 17, wherein the VAS unit is operable to filter the searched data based on a user's desire.

19. The multi-cloud fabric, as recited in claim 1, further including a service unit in communication with the controller and operative to configure data of a network based on rules.

20. The multi-cloud fabric, as recited in claim 19, wherein the network unit, the network is in communication with the resources.

21. The multi-cloud fabric, as recited in claim 1, wherein the controller including a cloud engine operable to assess multiple clouds relative to an application and resources.

22. The multi-cloud fabric, as recited in claim 1, wherein the controller including a network enablement engine.

23. The multi-cloud fabric, as recited in claim 1, wherein the application deployment fabric includes a plug-in unit responsive to applications with different format applications and operable to convert the different format applications to a native-format application.

24. The multi-cloud fabric, as recited in claim 1, wherein the application deployment fabric being operable to report configuration and analytics related to the resources.

25. The multi-cloud fabric, as recited in claim 1, wherein the multi-cloud fabric spans across multiple clouds.

26. The multi-cloud fabric, as recited in claim 1, wherein the cloud is a private cloud or a public.

27. The multi-cloud fabric, as recited in claim 1, wherein the cloud is a hybrid cloud.

28. The multi-cloud fabric, as recited in claim 1, wherein the multi-cloud fabric is operable to configure the resources and to monitor traffic of the resources and based at least on the monitored traffic, re-configure the resources.

29. The multi-cloud fabric, as recited in claim 27, wherein the multi-cloud fabric is operable to monitor traffic in real-time and to re-configure the resources in real-time.

30. The multi-cloud fabric, as recited in claim 1, wherein the multi-cloud fabric is operable to stitch across the cloud and at least one more cloud.

31. The multi-cloud fabric, as recited in claim 1, wherein the multi-cloud fabric is operable to stitch network services.

32. The multi-cloud fabric, as recited in claim 30, wherein the network services are stitched in real-time.

33. The multi-cloud fabric, as recited in claim 1, wherein the multi-cloud fabric is operable to burst across clouds other than the cloud and access existing resources.

34. The multi-cloud fabric, as recited in claim 1, wherein the controller is responsive to test traffic and operative to generate to test traffic.

35. The multi-cloud fabric, as recited in claim 33, wherein the multi-cloud fabric is operable to configure resources based on the test traffic.

36. The multi-cloud fabric, as recited in claim 1, wherein upon violation of a policy, the multi-cloud fabric automatically scales out or scales in the resources.

37. The multi-cloud fabric, as recited in claim 1, wherein the controller further includes an service level agreement (SLA) engine operable to monitor and set parameters of different types of SLAs in real-time.

38. The multi-cloud fabric, as recited in claim 36, wherein the SLA includes application SLA and networking SLA.

39. The multi-cloud fabric, as recited in claim 1, wherein the multi-cloud fabric is distributed.

40. The application deliver fabric, as recited in claim 1, wherein the application management unit is operable to receive more than one application with different formats and to generate native-format applications from the more than one application.

41. The multi-cloud fabric, as recited in claim 1, wherein the resources include storage systems, servers, routers, switches, or any combination thereof.
